(19) United States
(12) Patent Application Publication
(10) Pub. No.: US 2023/0085141 A1
(43) Pub. Date: Mar. 16, 2023

(54) CELL BALANCE CIRCUIT, CELL BALANCE DEVICE, CHARGE/DISCHARGE CONTROL CIRCUIT, CHARGE/DISCHARGE CONTROL DEVICE, AND BATTERY DEVICE

(71) Applicant: ABLIC Inc., Tokyo (JP)

(72) Inventors: Fumihiko MAETANI, Tokyo (JP); Kanae KUROSE, Tokyo (JP)

(73) Assignee: ABLIC Inc., Tokyo (JP)

(21) Appl. No.: 17/942,182

(22) Filed: Sep. 12, 2022

(30) Foreign Application Priority Data
Sep. 14, 2021 (JP) 2021-149059
Dec. 9, 2021 (JP) 2021-199861

(51) Int. Cl. H02J 7/00; H01M 10/42; H01M 10/44

(52) U.S. Cl. CPC H02J 7/0019; H01M 10/425; H02J 7/00302; H01M 10/441; H01M 2010/4271

(57) ABSTRACT

The cell balance circuit is a circuit connected in parallel to a secondary battery including a battery pack in which a first cell to an n^{th} cell (n is plural) are connected in series in order from a positive electrode to a negative electrode and adjusting individual voltages of n cells. The cell balance circuit includes a switch circuit which can respectively open/close paths connected to n cells, and a cell discharge resistor respectively connected to the first cell to the n^{th} cell via the switch circuit. The switch circuit switches to a cell balance stop state where each of the first cell to the n^{th} cell is not connected to the cell discharge resistor in at least one state of a state where a charger is not connected to an external terminal, or a state where the secondary battery is being discharged to a load.

### CROSS-REFERENCE TO RELATED APPLICATION

This application claims the priority benefits of Japanese application no. 2021-149059, filed on Sep. 14, 2021, and Japanese application no. 2021-199861, filed on Dec. 9, 2021. The entirety of each of the above-mentioned patent applications is hereby incorporated by reference herein and made a part of this specification.

### BACKGROUND

### Technical Field

The present invention relates to a cell balance circuit, a cell balance device, a charge/discharge control circuit, a charge/discharge control device, and a battery device.

### Description of Related Art

There is a battery pack configured by connecting a plurality of battery cells of a chargeable/dischargeable secondary battery in series. As the battery pack, as a secondary battery, is repeatedly charged and discharged, the voltage of each battery cell thereof deviates. If the voltage of each battery cell in the battery pack is significantly different, there is a risk that a battery cell with a high voltage may become overcharged immediately and stop charging when the battery pack is charged, a battery cell with a low voltage may become overdischarged immediately and stop discharging when the battery pack is discharged, and both the charging and discharging can only be performed a little. Thus, it is preferable to adjust the voltage of each battery cell in the battery pack to be substantially uniform.

Thus, from the viewpoint of suppressing the voltage deviation between the battery cells within a predetermined range, there is a cell balance technique which operates to make the voltages between the battery cells in the battery pack uniform (hereinafter referred to as “cell balance operation”).

A conventional cell balance operation as described above is an operation which causes a current to flow through a discharge path from a battery cell with a relatively high voltage. In this cell balance operation, the voltage is made uniform with the voltage of another battery cell with a relatively low voltage by discharging the battery cell with a relatively high voltage. In a charge/discharge control circuit applying the conventional cell balance operation, the cell balance operation is performed until the voltage difference between the battery cell having the maximum voltage and the battery cell having the minimum voltage falls within a predetermined range.

However, in the conventional cell balance device which performs the cell balance operation described above, the cell balance operation is continued if the voltage difference between the battery cell with the maximum voltage and the battery cell with the minimum voltage is not within the predetermined range, and it does not take into account the state of the battery such as whether each battery cell is overcharged, whether a charger is connected, and whether the battery pack is discharged to an apparatus. Thus, the conventional cell balance device cannot perform the cell balance operation according to the state of the battery or the connection with the charger or the apparatus as a load, and there is room for improvement from the viewpoint of energy saving.

In addition, the conventional cell balance device includes a circuit for measuring the voltage of each battery cell and a circuit for comparing the measured voltage, as the circuits for performing the cell balance operation, and the number of circuits is relatively large. An increase in the number of circuits leads to an increase in the number of circuits to be tested. As described above, the conventional cell balance device having a relatively large number of circuits has room for improvement from the viewpoint of resources saving or cost.

### SUMMARY

The present invention provides a cell balance circuit, a cell balance device, a charge/discharge control circuit, a charge/discharge control device, and a battery device which reduce energy loss associated with the cell balance operation. Further, the present invention provides a cell balance circuit, a cell balance device, a charge/discharge control circuit, a charge/discharge control device, and a battery device capable of performing the cell balance operation with an accuracy equal to or higher than the conventional technique by a simpler configuration than the conventional technique.

A cell balance circuit in accordance with at least one embodiment of the present invention is a circuit connected in parallel to a secondary battery including a battery pack in which a first cell to an n^{th} cell are connected in series in order from a positive electrode to a negative electrode, with a natural number n which is two or more as the number of cells connected in series, and adjusting individual voltages of n cells, from the first cell to the n^{th} cell. The cell balance circuit includes: a switch circuit including at least one switch in a path connecting a positive electrode terminal and a negative electrode terminal of each of the n cells and being capable of respectively opening/closing n paths based on a control signal supplied to the at least one switch; and a cell discharge resistor respectively connected to the n cells, from the first cell to the n^{th} cell, via the switch circuit. The switch circuit switches to a cell balance stop state where each of the first cell to the n^{th} cell is not connected to the cell discharge resistor in response to satisfying at least one of a charger non-connection state where a charger for charging the secondary battery is not connected to an external positive electrode terminal and an external negative electrode terminal, or a state where the secondary battery is being discharged to a load connected to the external positive electrode terminal and the external negative electrode terminal.

A cell balance circuit in accordance with at least one embodiment of the present invention is a circuit connected in parallel to a secondary battery including a battery pack in which a first cell and a second cell are connected in series from a positive electrode to a negative electrode, and adjusting individual voltages of the first cell and the second cell. The cell balance circuit includes: a switch circuit including at least one switch in a path connecting a positive electrode terminal and a negative electrode terminal of each of the first cell and the second cell and being capable of respectively opening/closing two paths based on a control signal supplied to the at least one switch; and a cell discharge resistor respectively connected to the first cell and the second cell via the switch circuit. An overcharge detection voltage for detecting an overcharge state and an overcharge release voltage for releasing the overcharge state are respectively set for voltages of the first cell and the second cell. The overcharge release voltage is set to a voltage lower than a voltage which is ½ times a charge voltage, which is an output voltage of a charger for charging the secondary battery. The overcharge detection voltage is set to a voltage higher than the voltage which is ½ times the charge voltage and lower than the charge voltage. A release condition of the overcharge state in a charger connection state where the charger is connected to an external positive electrode terminal and an external negative electrode terminal is that a voltage of the cell, among the first cell and the second cell, drops to the overcharge release voltage or less, the voltage exceeding the overcharge detection voltage.

Further, the cell balance device, the charge/discharge control circuit, the charge/discharge control device, and the battery device according to one embodiment of the present invention include the cell balance circuit.

According to the cell balance circuit, the cell balance device, the charge/discharge control circuit, the charge/discharge control device, and the battery device, the energy loss associated with the cell balance operation can be reduced.

### BRIEF DESCRIPTION OF THE DRAWINGS

FIG. 1 is a schematic diagram illustrating a configuration example of the cell balance circuit, the charge/discharge control circuit, the charge/discharge control device, and the battery device according to the first embodiment of the present invention.

FIG. 2 is a schematic diagram illustrating a detailed configuration example of the charge/discharge control circuit according to the first embodiment.

FIG. 3 is a schematic diagram illustrating a detailed configuration example of the cell balance circuit according to the first embodiment.

FIG. 4 is a schematic diagram illustrating a configuration example of the cell balance circuit, the cell balance device, the charge/discharge control circuit, the charge/discharge control device, and the battery device according to the second embodiment of the present invention.

FIG. 5 is a schematic diagram illustrating a detailed configuration example of the charge/discharge control circuit according to the second embodiment.

FIG. 6 is a schematic diagram illustrating a detailed configuration example of the cell balance circuit and the cell balance device according to the second embodiment.

FIG. 7 is a schematic diagram illustrating a configuration example of the cell balance circuit, the charge/discharge control circuit, the charge/discharge control device, and the battery device according to the third embodiment of the present invention.

FIG. 8 is a schematic diagram illustrating a detailed configuration example of the charge/discharge control circuit according to the third embodiment.

FIG. 9 is a schematic diagram illustrating a detailed configuration example of the cell balance circuit according to the third embodiment.

FIG. 10 is a schematic diagram illustrating a configuration example of the cell balance circuit, the cell balance device, the charge/discharge control circuit, the charge/discharge control device, and the battery device according to the fourth embodiment of the present invention.

FIG. 11 is a schematic diagram illustrating a detailed configuration example of the charge/discharge control circuit according to the fourth embodiment.

FIG. 12 is a schematic diagram illustrating a detailed configuration example of the cell balance circuit and the cell balance device according to the fourth embodiment.

FIG. 13 is a schematic diagram illustrating a configuration example of a modified example of the cell balance circuit according to the third and fourth embodiments of the present invention.

### DESCRIPTION OF THE EMBODIMENTS

Hereinafter, the cell balance circuit, the cell balance device, the charge/discharge control circuit, the charge/discharge control device, and the battery device according to the embodiments of the present invention will be described with reference to the drawings.

### First Embodiment

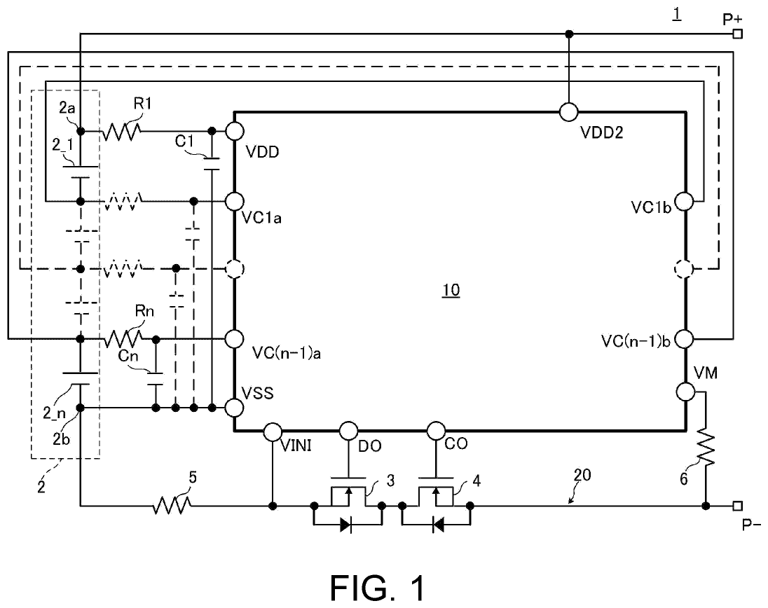

FIG. 1 is a schematic diagram illustrating a configuration example of the cell balance circuit, the charge/discharge control circuit, the charge/discharge control device, and the battery device according to the first embodiment.

A battery device 1 and a charge/discharge control circuit 10 are examples of the battery device and the charge/discharge control circuit according to the first embodiment, respectively. The battery device 1 includes a secondary battery 2 which includes a so-called multi-cell configuration battery pack, an external positive electrode terminal P+ and an external negative electrode terminal P−, a discharge control FET (Field Effect Transistor) 3, a charge control FET 4, and the charge/discharge control circuit 10 for controlling the charge/discharge of the secondary battery 2. From the viewpoint of simplifying the description, the external positive electrode terminal P+ and the external negative electrode terminal P− may be collectively referred to as “external terminal” in the following description.

A charge/discharge control device 20 is an example of the charge/discharge control device according to the first embodiment. The charge/discharge control device 20 includes the external positive electrode terminal P+ and the external negative electrode terminal P−, the discharge control FET 3, the charge control FET 4, and the charge/discharge control circuit 10. That is, the charge/discharge control device 20 is a device in which the secondary battery 2 is omitted from the battery device 1.

The secondary battery 2 is a so-called multi-cell battery including a battery pack in which a plurality of battery cells (hereinafter simply referred to as “cells”) are connected in series. That is, assuming that the number of cells connected in series is “n,” n is a natural number of 2 or more, that is, a plural. The n cells 2_1, . . . , 2_n in the secondary battery 2 are connected in series in this order from the positive electrode 2a of the secondary battery 2 toward the negative electrode 2b of the secondary battery 2.

The external positive electrode terminal P+ and the external negative electrode terminal P− are terminals for connecting to a charger and an external apparatus such as a load (not illustrated). In the battery device 1, the secondary battery 2, an overcurrent detection resistor 5, the discharge control FET 3, and the charge control FET 4 are connected in this order from the side of the external positive electrode terminal P+, for example, in the path connecting the external positive electrode terminal P+ and the external negative electrode terminal P− (hereinafter referred to as “external terminal-to-terminal path”).

The battery device 1 and the charge/discharge control device 20 include the discharge control FET 3 and the charge control FET 4 on the side of the external negative electrode terminal P−, that is, the low side. The discharge control FET 3 and the charge control FET 4 are both NMOS transistors, and have drains connected to each other.

The discharge control FET 3 includes a gate connected to the discharge control signal output terminal DO, a drain connected to the drain of the charge control FET 4, and a source connected to one end of the overcurrent detection resistor 5.

The charge control FET 4 includes a gate connected to the charge control signal output terminal CO, a source connected to the external negative electrode terminal P−, and a drain connected to the drain of the discharge control FET 3.

The charge/discharge control circuit 10 is composed of, for example, one semiconductor chip, that is, a semiconductor integrated circuit. The charge/discharge control circuit 10 includes positive electrode power supply terminals VDD and VDD2, a negative electrode power supply terminal VSS, cell connection terminals VC1a, . . . , VC(n−1)a and VC1b, . . . , VC(n−1)b, a charge control signal output terminal CO, a discharge control signal output terminal DO, an external negative voltage input terminal VM, and an overcurrent detection terminal VINI.

The positive electrode power supply terminal VDD is connected to the positive electrode 2a via the resistor R1, and the voltage from the positive electrode 2a of the secondary battery 2 is supplied. The positive electrode power supply terminal VDD2 is connected to the external positive electrode terminal P+ and the positive electrode 2a, and the voltage from the positive electrode 2a of the secondary battery 2 is supplied. The negative electrode power supply terminal VSS is connected to the negative electrode 2b, and the voltage from the negative electrode 2b is supplied.

The cell connection terminal VC1a and the cell connection terminal VC1b are respectively connected to the contacts of the adjacent first cell 2_1 and second cell 2_2, that is, the negative electrode terminal of the first cell 2_1 and the positive electrode terminal of the second cell 2_2, via the resistor R2. Hereinafter, in the same manner as the cell connection terminals VC1a and VC1b, the cell connection terminals VC2a and VC2b, . . . , and VC(n−1)a and VC(n−1)b are respectively connected to the negative electrode terminal of the second cell 2_2 and the positive electrode terminal of the third cell 2_3, . . . , and the negative electrode terminal of the n−1th cell 2_(n−1) and the positive electrode terminal of the n^{th} cell 2_n via the resistors R3, . . . and Rn. A pair of the cell connection terminal VC1a as a first terminal and the cell connection terminals VC1b as a second terminal constitutes a cell connection terminal pair VC1a, VC1b. In the same manner as the cell connection terminal pair VC1a, VC1b, each of pairs of the cell connection terminals VC2a, . . . , and VC(n−1)a as the first terminals and the cell connection terminals VC2b, . . . , and VC(n−1)b as the second terminals constitute cell connection terminal pairs VC2a, VC1b; . . . ; and VC(n−1)a, VC(n−1)b.

Here, the ends (the ends on the left side in FIG. 1) of the resistors R1, . . . , Rn connected to the first cell 2_1 to the n^{th} cell 2_n are referred to as the first ends, and the ends connected to the positive electrode power supply terminal VDD, the cell connection terminal VC1a, . . . , VC(n−1)a, and the negative electrode power supply terminal VSS, that is, the ends in the direction opposite to the first ends, are referred to as the second ends (the ends on the right side in FIG. 1).

A capacitor C1 for suppressing voltage fluctuation is connected between the contact between the second end of the resistor R1 and the positive electrode power supply terminal VDD and the contact between the negative electrode 2b and the negative electrode power supply terminal VSS. Hereinafter, in the same manner as the capacitor C1, the capacitors C2, . . . , Cn are respectively connected between the contacts between the second ends of the resistors R2, . . . , Rn and the cell connection terminals VC1a, . . . , VC(n−1)a and the contacts between the negative electrode 2b and the negative electrode power supply terminal VSS.

The charge control signal output terminal CO is a terminal which outputs a charge control signal for controlling the stop and permission of charge of the secondary battery 2 generated in the charge/discharge control circuit 10 to the outside of the charge/discharge control circuit 10. The charge control signal output terminal CO is connected to the gate of the charge control FET 4.

The discharge control signal output terminal DO is a terminal which outputs a discharge control signal for controlling the stop and permission of discharge of the secondary battery 2 generated in the charge/discharge control circuit 10 to the outside of the charge/discharge control circuit 10. The discharge control signal output terminal DO is connected to the gate of the discharge control FET 3.

The external negative voltage input terminal VM is connected to the external negative electrode terminal P− and the source of the charge control FET 4 via the resistor 6.

The overcurrent detection terminal VINI is connected to one end of the overcurrent detection resistor 5 and the source of the discharge control FET 3.

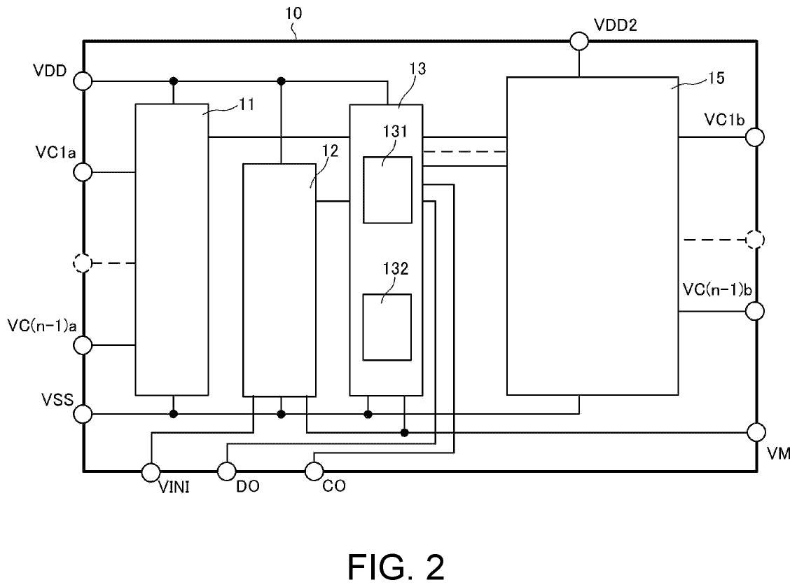

FIG. 2 is a schematic diagram illustrating a more detailed configuration example of the charge/discharge control circuit 10 as the charge/discharge control circuit according to the first embodiment.

The charge/discharge control circuit 10 further includes a battery voltage detection circuit 11, an overcurrent detection and release circuit 12, a control circuit 13, and a cell balance circuit 15 in addition to the positive electrode power supply terminals VDD and VDD2, the negative electrode power supply terminal VSS, the cell connection terminals VC1a, . . . , VC(n−1)a and VC1b, . . . , VC(n−1)b, the charge control signal output terminal CO, the discharge control signal output terminal DO, the external negative voltage input terminal VM, and the overcurrent detection terminal VINI.

The battery voltage detection circuit 11 is a circuit which detects the voltage between the terminals included in the secondary battery 2. The battery voltage detection circuit 11 includes a terminal connected to the positive electrode power supply terminal VDD, a terminal connected to the negative electrode power supply terminal VSS, terminals respectively connected to the cell connection terminals VC1a, . . . , VC(n−1)a, and a terminal connected to the control circuit 13.

The overcurrent detection and release circuit 12 includes an overcurrent detection circuit for detecting the overcurrent state and an overcurrent release circuit for releasing the overcurrent state and transitioning from the overcurrent state to the normal state. Further, the overcurrent detection and release circuit 12 includes a terminal connected to the positive electrode power supply terminal VDD, a terminal connected to the overcurrent detection terminal VINI, a terminal connected to the external negative voltage input terminal VM, and a terminal connected to the control circuit 13.

The control circuit 13 includes a terminal connected to the positive electrode power supply terminal VDD, a terminal connected to the negative electrode power supply terminal VSS, a terminal connected to the charge control signal output terminal CO, a terminal connected to the discharge control signal output terminal DO, a terminal connected to the external negative voltage input terminal VM, a terminal connected to the battery voltage detection circuit 11, a terminal connected to the overcurrent detection and release circuit 12, and a terminal connected to the cell balance circuit 15.

Further, the control circuit 13 includes an FET control circuit 131 and a cell balance control circuit 132. The FET control circuit 131 generates a control signal for controlling the charge/discharge of the secondary battery 2 based on the detection signals of the voltage of the secondary battery 2 from the battery voltage detection circuit 11 and the voltage of each cell 2_1, . . . , 2_n, and supplies the control signal to the charge control signal output terminal CO and the discharge control signal output terminal DO. The cell balance control circuit 132 generates a control signal for adjusting the individual voltages of the first cell 2_1 to the n^{th} cell 2_n based on the detection signals of the voltage of the secondary battery 2 from the battery voltage detection circuit 11 and the voltage of each cell 2_1, . . . , 2_n, the voltage of the negative electrode power supply terminal, and the voltage of the external negative voltage input terminal, and supplies the control signal to the cell balance circuit 15.

The cell balance circuit 15 is a circuit which performs a cell balance operation for adjusting the individual voltages of the first cell 2_1 to the n^{th} cell 2_n. The cell balance circuit 15 includes a terminal connected to the positive electrode power supply terminal VDD2, a terminal connected to the negative electrode power supply terminal VSS, a terminal connected to the control circuit 13, and terminals respectively connected to the cell connection terminals VC1b, . . . , VC(n−1)b.

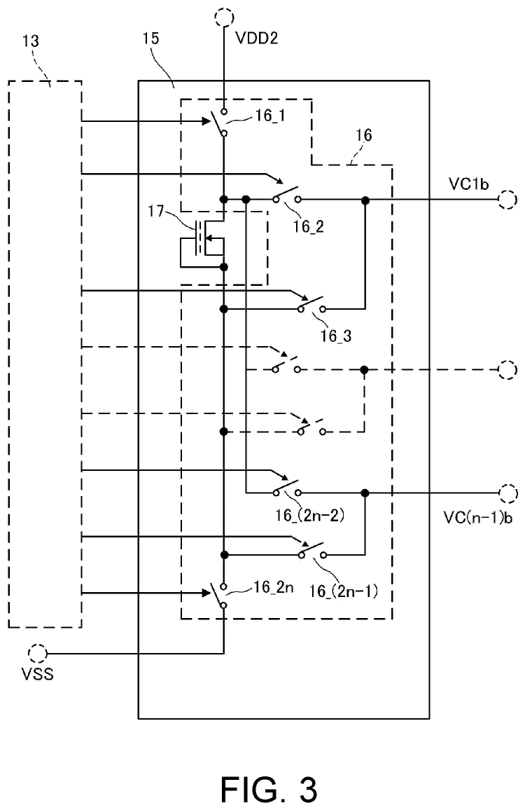

FIG. 3 is a schematic diagram illustrating a more detailed configuration example of the cell balance circuit 15 as the cell balance circuit according to the first embodiment.

The cell balance circuit 15 includes a switch circuit 16 and a depletion type FET 17 as a cell discharge resistor.

The switch circuit 16 is provided between the respective terminals of the positive electrode power supply terminal VDD2, the negative electrode power supply terminal VSS, and the cell connection terminals VC1b, . . . , VC(n−1)b and the depletion type FET 17.

The switch circuit 16 includes two which is at least one, that is, 2n switches 16_1, 16_2, . . . , 16_(2n−1), 16_2n which are twice the number of cells of the secondary battery 2, respectively in n paths connecting the positive electrode terminals and the negative electrode terminals of the cells 21, . . . , 2_n. As the switch circuit 16 includes the switches 161, 16_2, . . . , 16_(2n-1), 16_2n, the switch circuit 16 is configured to be capable of opening/closing the n paths connecting the positive electrode terminals and the negative electrode terminals of the cells 21, . . . , 2n.

Here, in the switches 16_1, 16_2, . . . , 16_(2n−1), 16_2n, the ports connected to the respective terminals of the positive electrode power supply terminal VDD2, the negative electrode power supply terminal VSS, and the cell connection terminals VC1b, . . . , VC(n−1)b, that is, the positive electrode terminals of the cells 2_1, . . . , 2_n, are referred to as the first ports. Further, the ports connected to the drain or source of the depletion type FET 17 are referred to as the second ports.

The switches 16_1, 16_2, . . . , 16_(2n−1), 16_2n each include a first port and a second port, and a control port. Each switch 16_1, 162, . . . , 16_(2n−1), 16_2n is configured to be capable of switching between a short circuit (closed state) and open (opened state) of the first port and the second port according to the control signal received at the control port.

The second ports of the switch 16_1 and the switches 162, . . . , 16_(2n−2), which are half (n) of the switches 16_1, 162, . . . , 16_(2n−1), 16_2n, are connected to the drain of the depletion type FET 17. The second ports of the switches 163, . . . , 16_(2n−1) and the switch 16_2n, which are the other half (n), are connected to the source of the depletion type FET 17.

Here, the group of the switch 16_1 and the switches 162, . . . , 16_(2n−2) having the second ports connected to the drain of the depletion type FET 17 as one port (first port) as the cell discharge resistor is referred to as the first switch group. Further, the group of the switches 16_3, . . . , 16_(2n−1) and the switch 16_2n having the second ports connected to the source of the depletion type FET 17 as the other port (second port) as the cell discharge resistor is referred to as the second switch group.

The n switch 16_1 and switches 162, . . . , 16_(2n−2) forming the first switch group are switches for switching between connection and non-connection with the positive electrode terminals of the first cell 2_1 to the n^{th} cell 2_n, respectively. The n switches 16_3, . . . , 16_(2n−1) and switch 16_2n forming the second switch group are switches for switching between connection and non-connection with the negative electrode terminals of the first cell 2_1 to the n^{th} cell 2_n, respectively.

The depletion type FET 17 as the cell discharge resistor is, for example, an N type depletion type MOSFET. In the depletion type FET 17, the gate and the source are connected (short-circuited).

Next, the operation of the cell balance circuit 15, the charge/discharge control circuit 10, the charge/discharge control device 20, and the battery device 1 configured as described above will be described.

The charge/discharge control circuit 10, the charge/discharge control device 20, and the battery device 1 perform an operation of switching between the normal state, the discharge prohibition state, the charge prohibition state, and the overcurrent detection state, that is, the charge/discharge control operation of the secondary battery 2 in the same manner as the conventional charge/discharge control circuit, charge/discharge control device, and battery device. The overcurrent detection state includes a discharge overcurrent detection state in which an overcurrent is detected when the secondary battery 2 is discharged, and a charge overcurrent detection state in which an overcurrent is detected when the secondary battery 2 is charged. In addition, the charge/discharge control circuit 10, the charge/discharge control device 20, and the battery device 1 perform a cell balance operation for adjusting the individual voltages of the first cell 2_1 to the n^{th} cell 2_n.

Furthermore, in the charge/discharge control circuit 10, the power supply voltage, that is, the voltage region corresponding to the voltage difference between the voltage Vdd of the positive electrode power supply terminal VDD2 and the voltage Vss of the negative electrode power supply terminal VSS is divided into n+1 voltage regions. Here, the n+1 voltage regions are respectively referred to as a first voltage region, a second voltage region, . . . , an n^{th} voltage region, and an n+1^{th} voltage region in order from the side of the voltage Vdd.

Further, in the charge/discharge control circuit 10 (more specifically, the control circuit 13), an overcharge detection voltage for starting an operation of overcharge protection and an overcharge release voltage for releasing (stopping) the operation of overcharge protection are set for each of the first cell 2_1 to the n^{th} cell 2_n. Further, in the charge/discharge control circuit 10 (more specifically, the control circuit 13), the conditions that the voltage of the secondary battery 2 becomes equal to or lower than the overcharge release voltage and that the discharge from the secondary battery 2 to the load connected between the external terminals is started are set as the conditions for releasing the operation of overcharge protection.

First, the charge/discharge control operation of the secondary battery 2 will be described. In the charge/discharge control circuit 10, the charge/discharge control device 20, and the battery device 1, the battery voltage detection circuit 11 detects the voltage between its own terminals and supplies a signal indicating the detected voltage to the control circuit 13.

The overcurrent detection and release circuit 12 detects whether there is an overcurrent based on the voltage received from the overcurrent detection terminal VINI, and supplies a signal indicating the overcurrent detection state or the overcurrent release state to the control circuit 13. The overcurrent detection and release circuit 12 detects an overcurrent, and outputs the overcurrent detection signal when a predetermined time has elapsed from the time point of transitioning from the overcurrent non-detection state to the overcurrent detection state.

On the other hand, the overcurrent detection and release circuit 12 outputs a signal for releasing the overcurrent state based on the voltage received from the external negative voltage input terminal VM in the overcurrent detection state. A signal indicating the determination result of the overcurrent detection and release circuit 12 is supplied to the control circuit 13.

The control circuit 13 generates the charge/discharge control signal for controlling on/off of the discharge control FET 3 and the charge control FET 4 based on at least one of the signal output by the battery voltage detection circuit 11, the determination result determined by the overcurrent detection and release circuit 12, and the voltage Vm of the external negative voltage input terminal VM, and supplies the generated charge/discharge control signal to the discharge control signal output terminal DO and the charge control signal output terminal CO, thereby controlling on/off of the discharge control FET 3 and the charge control FET 4. The charge/discharge control signal is generated by the FET control circuit 131.

Subsequently, the cell balance operation of the first cell 2_1 to the n^{th} cell 2_n will be described. The control circuit 13 is set with an operation start condition and an operation stop condition for the cell balance operation. In the charge/discharge control circuit 10, the cell balance operation is started when the operation start condition is satisfied, and the cell balance operation is stopped when the operation stop condition is satisfied.

In addition to the overcharge state where the charger is connected to the external positive electrode terminal P+ and the external negative electrode terminal P− to start charging the secondary battery 2, the voltage rises to be equal to or higher than the overcharge detection voltage in any of the first cell 2_1 to the n^{th} cell 2_n, and charge is prohibited, the operation start condition of the cell balance operation includes satisfying the following condition:

(I) a state where the charger is connected to the external positive electrode terminal P+ and the external negative electrode terminal P− (hereinafter referred to as “charger connection state”) remains, or

(II) a state where the charger is removed from the external positive electrode terminal P+ and the external negative electrode terminal P− and is not connected to the external positive electrode terminal P+ and the external negative electrode terminal P− (hereinafter referred to as “charger non-connection state”), but the discharge from the secondary battery 2 to the load connected to the external positive electrode terminal P+ and the external negative electrode terminal P− is not started.

Whether or not the secondary battery 2 is in the overcharge state and whether or not the condition (I) or (II) is satisfied is determined by the control circuit 13 based on at least one of the voltage detected by the battery voltage detection circuit 11, the determination result determined by the overcurrent detection and release circuit 12, the voltage Vss of the negative electrode power supply terminal VSS, and the voltage Vm of the external negative voltage input terminal VM.

In the charge/discharge control circuit 10, when the overcharge state is detected, the charge control FET 4 is turned from on to off, and the charge of the secondary battery 2 is stopped. Further, if the operation start condition of the cell balance operation of the condition (I) or (II) is satisfied, the transition to the cell balance operation state is permitted.

That is, after the operation start condition of the cell balance operation is satisfied, the charge/discharge control circuit 10 transitions between the cell balance operation state in which the depletion type FET 17 is connected in parallel to any one of the first cell 2_1 to the n^{th} cell 2_n, and a cell balance stop state in which the depletion type FET 17 is not connected to any of the first cell 2_1 to the n^{th} cell 2_n according to in which of the first voltage region to the n+1^{th} voltage region the voltage of the secondary battery 2 detected by the battery voltage detection circuit 11 exists.

Here, assuming that the order of the first cell 2_1 to the n^{th} cell 2_n from the positive electrode 2a to the negative electrode 2b is “k,” k is a natural number satisfying 1≤k≤n, that is, a natural number of n or less. The relationship between the divided n+1 voltage regions and the cell balance operation state and the cell balance stop state will be described more specifically using this k.

When the voltage of the secondary battery 2 exists in the k^{th} voltage region, it becomes a state where the depletion type FET 17 is connected in parallel to the k^{th} cell 2_k (hereinafter referred to as “k^{th} cell discharge state”). That is, the cell balance operation state includes n cell discharge states from the first cell discharge state to the n^{th} cell discharge state. Further, when the voltage of the secondary battery 2 exists in the n+1^{th} voltage region, it becomes the cell balance stop state.

The generation of a control signal for transitioning between the cell balance operation state and the cell balance stop state, that is, a control signal for adjusting the individual voltages of the first cell 2_1 to the n^{th} cell 2_n, is performed by the cell balance control circuit 132.

After the operation start condition of the cell balance operation is satisfied, when the voltage of the k^{th} cell 2_k exceeds the overcharge release voltage, the cell balance control circuit 132 generates a control signal for setting the charge/discharge control circuit 10 to the k^{th} cell discharge state, and supplies the control signal to the respective control ports of the switches 16_1, 16_2, . . . , 16_(2n−1), 16_2n.

The switches 16_1, 16_2, . . . , 16_(2n−1), 16_2n receiving the control signal for setting the charge/discharge control circuit 10 to the k^{th} cell discharge state are controlled to be opened/closed (open or short circuit) so that the path in the switch circuit 16 is switched and controlled, and the depletion type FET 17 is connected in parallel to the k^{th} cell 2_k. When the depletion type FET 17 is connected in parallel to the k^{th} cell 2_k, a cell balance current flows so as to reduce the voltage of the k^{th} cell 2_k.

In the k^{th} cell discharge state, two of the 2n switches 16_1, 16_2, . . . , 16_(2n−1), 16_2n, which connect the k^{th} cell 2_k and the depletion type FET 17 in parallel, are closed while the remaining 2n−2 switches are opened. By such opening/closing control of the switches 16_1 to 16_2n, any one of the first cell 2_1 to the n^{th} cell 2_n and the depletion type FET 17 are connected in parallel.

For example, when the charge/discharge control circuit 10 is transitioned to the first cell discharge state (when k=1), the switches 16_1 and 16_3 are closed while the remaining switches 16_2, 16_4, . . . , 16_2n are opened. By the opening/closing control of the switches 16_1, . . . , 16_2n, the cell balance circuit 15 is connected to the first cell 21 via the positive electrode power supply terminal VDD2 and the cell connection terminal VC1b. That is, the depletion type FET 17 is connected in parallel to the first cell 2_1.

When the charge/discharge control circuit 10 is transitioned to the n^{th} cell discharge state (when k=n), the switches 16_(2n−2) and 16_2n, which are two of the switches 16_1 to 16_2n, are closed while the remaining n−2 switches 16_1, . . . , 16_(2n−3), 16_(2n−1) are opened.

By such opening/closing control of the switches 16_1 to 16_2n, the depletion type FET 17 is connected in parallel to the n^{th} cell 2_n.

When the voltage of the secondary battery 2 exists in the n+1^{th} voltage region, the charge/discharge control circuit 10 is in the cell balance stop state, but when the operation stop condition of the next cell balance operation satisfies that:

(i) the voltage which has risen to be equal to or higher than the overcharge detection voltage has dropped to be equal to or lower than the overcharge release voltage, or

(ii) at least one of (a) the discharge from the secondary battery 2 to the apparatus which is the load has started and (b) it is the charger non-connection state, the charge/discharge control circuit 10 enters the cell balance stop state regardless of the voltage of the secondary battery 2.

The condition (i) and the condition (ii) are examples of timings at which it is preferable to suppress the discharge of the cells 2_1 to 2_n. The charge/discharge control circuit 10 is configured to be in the cell balance stop state at the timing when it is preferable to suppress such discharge of the cells 2_1 to 2_n. Whether or not the condition (i) or (ii) is satisfied is determined by the control circuit 13 based on at least one of the voltage detected by the battery voltage detection circuit 11, the voltage Vss of the negative electrode power supply terminal VSS, and the voltage Vm of the external negative voltage input terminal VM.

When the charge/discharge control circuit 10 is in the cell balance stop state, the opening/closing of the switches 16_1, 16_2, . . . , 16_(2n−1), 16_2n is controlled so that the cell balance current does not flow from any of the first cell 2_1 to the n^{th} cell 2_n. For example, the switch 16_2n is closed while the remaining switches 16_1, . . . , 16_(2n−1) are opened so that the cell balance circuit 15 is connected to the negative electrode power supply terminal VSS to be opened to any of the first cell 2_1 to the n^{th} cell 2_n.

Further, among the condition (i) and the condition (ii), the condition (i) and the condition (ii) (a) are also conditions for releasing the operation of overcharge protection. When the condition (i) and the condition (ii) (a) are satisfied, the charge control FET 4 transitions from off to on, and the charge/discharge control circuit 10 is in the cell balance operation stop state. In addition, when the condition (ii) (b) is satisfied, the charge/discharge control circuit 10 is in the cell balance operation stop state without the operation of overcharge protection being released.

As described above, in the charge/discharge control circuit 10, the charge/discharge control device 20, and the battery device 1, by controlling the opening/closing of the switches 16_1, 16_2, . . . , 16_(2n−1), 16_2n, the state is switched to either the cell balance operation state (from the first cell discharge state to the n^{th} cell discharge state) or the cell balance stop state.

Further, when switching to the cell balance stop state, for example, at the timing when it is preferable to suppress the discharge of the cells 2_1 to 2_n, such as when the state of discharging from the secondary battery 2 to the apparatus which is the load or the charger non-connection state is determined, the cell balance operation is interrupted and the cell balance operation is stopped even if the voltage difference between the cell with the maximum voltage and the cell with the minimum voltage is not within the predetermined range.

According to the present embodiment, the cell balance circuit 15 can switch between the cell balance operation state and the cell balance stop state according to the state of the secondary battery 2 (first cell 2_1 to the n^{th} cell 2_n) or the connection with the charger. This is a major difference between the present embodiment and the conventional cell balance device which cannot switch to the cell balance stop state until the voltage difference between the cell with the maximum voltage and the cell with the minimum voltage falls within the predetermined range when the voltage difference between the cell with the maximum voltage and the cell with the minimum voltage is not within the predetermined range.

As described above, the cell balance circuit 15 and the charge/discharge control circuit 10, the charge/discharge control device 20, and the battery device 1 including the cell balance circuit 15 include the switch circuit 16 which is capable of stopping the cell balance operation at the timing when it is desired to suppress the discharge of the cells 2_1 to 2_n. According to the present embodiment, even when the voltage difference between the cell with the maximum voltage and the cell with the minimum voltage is not within the predetermined range, the cell balance operation can be stopped at the timing when it is preferable to suppress the discharge of the cells 2_1 to 2_n, and the energy loss associated with the cell balance operation can be reduced.

Besides, the cell balance circuit 15 and the charge/discharge control circuit 10, the charge/discharge control device 20, and the battery device 1 including the cell balance circuit 15 allow the cell balance operation, that is, execute the cell balance operation without stopping the cell balance operation at the timing when it is not necessary to suppress the discharge of the cells 2_1 to 2_n such as the charger connection state and the state where the discharge of the secondary battery 2 is not started. For example, by leaving the charger connected for a long time or leaving the secondary battery 2 alone without connecting the apparatus to the external terminal after charging, the cell balance operation is executed so that the voltage difference between the cell with the maximum voltage and the cell with the minimum voltage can be reduced while excessive energy loss is suppressed.

As described above, the cell balance circuit 15 and the charge/discharge control circuit 10, the charge/discharge control device 20, and the battery device 1 including the cell balance circuit 15 include the depletion type FET 17 which includes the first port connected to the n positive electrode terminals of the first cell 2_1 to the n^{th} cell 2_n via the switch circuit 16 and the second port connected to the n negative electrode terminals of the first cell 2_1 to the n^{th} cell 2_n via the switch circuit 16. In the cell balance circuit 15 and the charge/discharge control circuit 10, the charge/discharge control device 20, and the battery device 1 including the cell balance circuit 15, with one depletion type FET 17, it is possible to switch the switches 16_1 to 16_2n open/close (open or short circuit) to selectively discharge each of the first cell 2_1 to the n^{th} cell 2_n.

Thus, in the cell balance circuit 15 and the charge/discharge control circuit 10, the charge/discharge control device 20, and the battery device 1 including the cell balance circuit 15, the configuration of the cell discharge resistor can be simplified and the heat generation location can be limited to one location.

### Second Embodiment

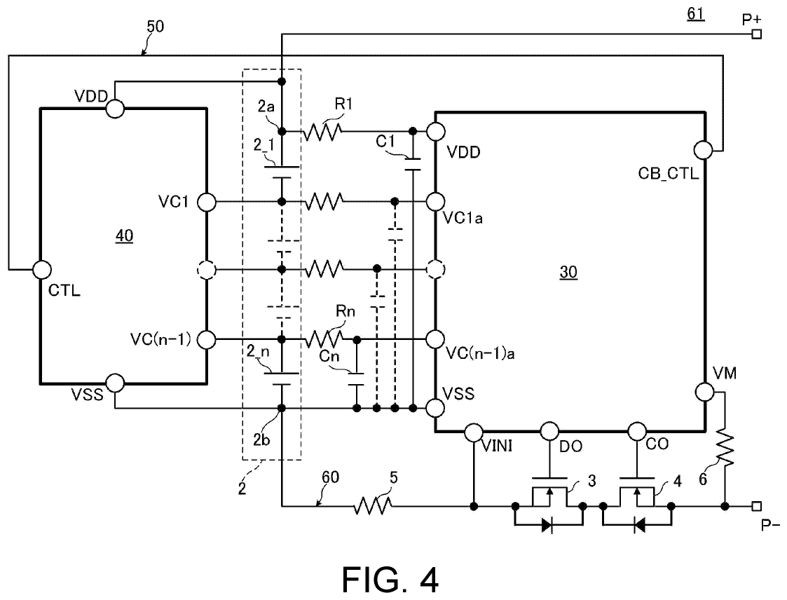

FIG. 4 is a schematic diagram illustrating a configuration example of the cell balance device, the charge/discharge control circuit, the charge/discharge control device, and the battery device according to the second embodiment.

The battery device 61, the charge/discharge control device 60, and the charge/discharge control circuit 50 are examples of the battery device, the charge/discharge control device, and the charge/discharge control circuit according to the second embodiment, respectively. The battery device 61 and the charge/discharge control device 60 are respectively different from the battery device 1 and the charge/discharge control device 20 in that the battery device 61 and the charge/discharge control device 60 include a charge/discharge control circuit 50 instead of the charge/discharge control circuit 10, but are the same in the other points.

Furthermore, the charge/discharge control circuit 50 is different from the charge/discharge control circuit 10 in that the FET control circuit 131 and the cell balance circuit 15 are formed on two semiconductor chips 30 and 40 which are different from each other, in that the charge/discharge control circuit 50 includes the control circuit 33 having the FET control circuit 131 instead of the control circuit 13 having the FET control circuit 131 and the cell balance control circuit 132, and the control circuit 43 corresponding to the cell balance control circuit 132, in that the control circuit 43 and the cell balance circuit 15 are configured as the independent cell balance device 41, and in that the output circuit 34 connecting the control circuit 33 and the control circuit 43 is further provided in the semiconductor chip 30, and the charge/discharge control circuit 50 is configured in the same manner as the charge/discharge control circuit 10 except for the above differences.

In the second embodiment, the differences between the charge/discharge control circuit 50 and the charge/discharge control circuit 10 will be mainly described, and the descriptions overlapping with those of the cell balance circuit 15, the charge/discharge control circuit 10, the charge/discharge control device 20, and the battery device 1 will be omitted.

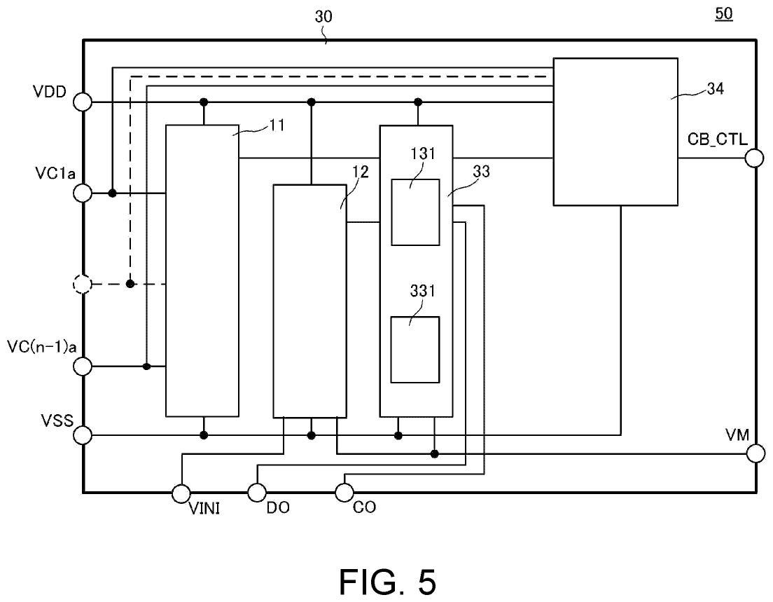

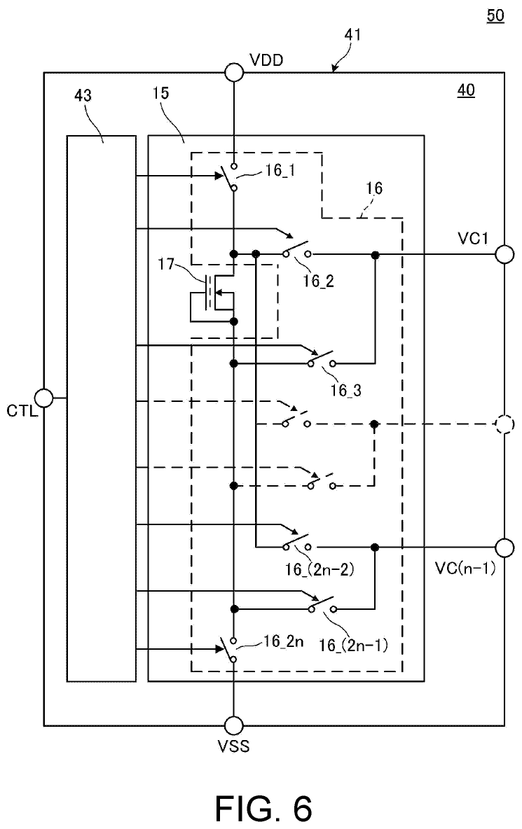

The charge/discharge control circuit 50 is dispersedly formed on a plurality of semiconductor chips which are two semiconductor chips 30 and 40, for example. That is, the charge/discharge control circuit 50 includes a circuit formed on the semiconductor chip 30 (see FIG. 5) and a circuit formed on the semiconductor chip 40 (see FIG. 6).

The semiconductor chip 30 as the first semiconductor chip includes the cell balance control signal terminal CB_CTL in addition to the positive electrode power supply terminal VDD, the negative electrode power supply terminal VSS, the cell connection terminals VC1a, . . . , VC(n−1)a, the charge control signal output terminal CO, the discharge control signal output terminal DO, the external negative voltage input terminal VM, and the overcurrent detection terminal VINI included in the charge/discharge control circuit 10.

The semiconductor chip 40 as the second semiconductor chip includes the positive electrode power supply terminal VDD corresponding to the positive electrode power supply terminal VDD2 in the charge/discharge control circuit 10, the cell connection terminals VC1, . . . , VC(n−1) corresponding to the cell connection terminals VC1b, . . . , VC(n−1)b in the charge/discharge control circuit 10, the negative power supply terminal VSS, and the signal input terminal CTL.

In the semiconductor chip 30, the connection destinations of the respective terminals of the positive electrode power supply terminal VDD, the negative electrode power supply terminal VSS, the cell connection terminals VC1a, . . . , VC(n−1)a, the charge control signal output terminal CO, the discharge control signal output terminal DO, the external negative voltage input terminal VM, and the overcurrent detection terminal VINI are the same as those of the charge/discharge control circuit 10. The cell balance control signal terminal CB_CTL is connected to the signal input terminal CTL.

In the semiconductor chip 40, the positive electrode power supply terminal VDD is connected to the positive electrode 2a and the external positive electrode terminal P+. The cell connection terminals VC1, . . . , VC(n−1) are respectively connected to the negative electrode terminal of the cell 2_1 and the positive electrode terminal of the cell 2_2, . . . , the negative electrode terminal of the cell 2_(n−1) and the positive electrode terminal of the cell 2_n. The negative electrode power supply terminal VSS is connected to the negative electrode 2b.

FIG. 5 is a schematic diagram illustrating a more detailed configuration example of the circuit formed in the semiconductor chip 30 in the charge/discharge control circuits 50 as the charge/discharge control circuit according to the second embodiment.

FIG. 6 is a schematic diagram illustrating a detailed configuration example of the circuit formed in the semiconductor chip 40, that is, the cell balance circuit and the cell balance device according to the second embodiment, in the charge/discharge control circuit 50 as the charge/discharge control circuit according to the second embodiment.

The charge/discharge control circuit 50 includes the positive electrode power supply terminal VDD, the negative electrode power supply terminal VSS, the cell connection terminals VC1a, . . . , VC(n−1)a, the charge control signal output terminal CO, the discharge control signal output terminal DO, the external negative voltage input terminal VM, the overcurrent detection terminal VINI, the cell balance control signal terminal CB_CTL, the battery voltage detection circuit 11, the overcurrent detection and release circuit 12, the control circuit 33, the output circuit 34, the signal input terminal CTL, the control circuit 43, the cell balance circuit 15, and the cell connection terminals VC1, . . . , VC(n−1).

The semiconductor chip 30 is formed with the positive electrode power supply terminal VDD, the negative electrode power supply terminal VSS, the cell connection terminals VC1a, . . . , VC(n−1)a, the charge control signal output terminal CO, the discharge control signal output terminal DO, the external negative voltage input terminal VM, the overcurrent detection terminal VINI, the cell balance control signal terminal CB_CTL, the battery voltage detection circuit 11, the overcurrent detection and release circuit 12, the control circuit 33, and the output circuit 34 in the charge/discharge control circuits 50.

The control circuit 33 includes a terminal connected to the positive electrode power supply terminal VDD, a terminal connected to the negative electrode power supply terminal VSS, a terminal connected to the charge control signal output terminal CO, a terminal connected to the discharge control signal output terminal DO, a terminal connected to the external negative voltage input terminal VM, a terminal connected to the battery voltage detection circuit 11, a terminal connected to the overcurrent detection and release circuit 12, and a terminal connected to the output circuit 34.

Further, the control circuit 33 includes the FET control circuit 131 and a determination circuit 331. The FET control circuit 131 generates a control signal for controlling the charge/discharge of the secondary battery 2 and supplies the control signal to the charge control signal output terminal CO and the discharge control signal output terminal DO. The determination circuit 331 determines a path between terminals connected in the cell balance circuit 15, that is, a path in the switch circuit 16.

The output circuit 34 is a circuit for outputting a signal representing the path between terminals connected in the cell balance circuit 15 from the semiconductor chip 30 to the semiconductor chip 40. The output circuit 34 includes a terminal connected to the positive electrode power supply terminal VDD, a terminal connected to the negative electrode power supply terminal VSS, terminals respectively connected to the cell connection terminals VC1a, . . . , VC(n−1)a, a terminal connected to the control circuit 33, and a terminal connected to the cell balance control signal terminal CB_CTL.

Further, the cell balance device 41 is formed on the semiconductor chip 40. The cell balance device 41 is an example of the cell balance device according to the second embodiment. The cell balance device 41 includes the positive electrode power supply terminal VDD, the negative electrode power supply terminal VSS, the cell balance circuit 15, the cell connection terminals VC1, . . . , VC(n−1), the signal input terminal CTL, and the control circuit 43 in the charge/discharge control circuit 50.

In the cell balance device 41, the positive electrode power supply terminal VDD is connected to the drain of the depletion type FET 17 via the switch 16_1. When focusing on the switch 16_1, the switch 16_1 has a first port connected to the positive electrode power supply terminal VDD, a second port connected to the drain of the depletion type FET 17, and a control port connected to the control circuit 43.

The negative electrode power supply terminal VSS is connected to the source of the depletion type FET 17 via the switch 16_2n. When focusing on the switch 16_2n, the switch 16_2n has a first port connected to the negative electrode power supply terminal VSS, a second port connected to the source of the depletion type FET 17, and a control port connected to the control circuit 43.

The cell connection terminal VC1 to the cell connection terminal VC(n−1) are respectively connected to the drain of the depletion type FET 17 via the switches forming the first switch group, and connected to the source of the depletion type FET 17 via the switches forming the second switch group.

For example, the cell connection terminal VC1 is connected to the drain of the depletion type FET 17 via the switch 16_2, and connected to the source of the depletion type FET 17 via the switch 16_3. Hereinafter, the cell connection terminal VC(n−1) is connected to the drain and source of the depletion type FET 17 via the switch in the same manner as the cell connection terminal VC1. The cell connection terminal VC(n−1) is connected to the source of the depletion type FET 17 via the switch 16_(2n−1).

The control circuit 43 as the cell balance control circuit is connected to the signal input terminal CTL. Further, the control circuit 43 is connected to the respective control ports of the switches 16_1, 16_2, . . . , 16_(2n−1), 16_2n.

The cell balance circuit 15 is an example of the cell balance circuit according to the second embodiment. The cell balance circuit 15 in the charge/discharge control circuit 50 is different from the cell balance circuit 15 in the charge/discharge control circuit 10 in that the cell balance circuit 15 is formed on the semiconductor chip 40 which is different from the semiconductor chip 30 on which the FET control circuit 131 is formed. Since they are the same in the other points, the same reference numerals are used in the present embodiment and the description thereof will be omitted.

Subsequently, the operation of the cell balance device 41, the charge/discharge control circuit 50, the charge/discharge control device 60, and the battery device 61 configured as described above will be described.

The charge/discharge control circuit 50, the charge/discharge control device 60, and the battery device 61 are respectively different from the charge/discharge control circuit 10, the charge/discharge control device 20, and the battery device 1 in that the cell balance operation is performed in the cell balance device 41, but there is no substantial difference in performing the charge/discharge control operation and the cell balance operation of the secondary battery 2 described above. In the second embodiment, the cell balance operation in the charge/discharge control circuit 50, the charge/discharge control device 60, and the battery device 61 will be mainly described, and the charge/discharge control operation of the secondary battery 2 will be omitted in the description of the charge/discharge control operation of the secondary battery 2 in the charge/discharge control circuit 10, the charge/discharge control device 20, and the battery device 1.

In the cell balance operation in the charge/discharge control circuit 50, the charge/discharge control device 60, and the battery device 61, first, the control circuit 33 determines whether to set to any of the first cell discharge state to the n^{th} cell discharge state and the cell balance stop state based on the voltage detected by the battery voltage detection circuit 11, the voltage Vss of the negative electrode power supply terminal VSS, and the voltage Vm of the external negative voltage input terminal VM, and supplies a signal indicating the determination result to the output circuit 34.

The signal indicating the determination result is a signal representing the path between the terminals connected in the cell balance circuit 15 and can be, for example, a signal indicating the opened/closed state to be transitioned for each switch 16_1, 16_2, . . . , 16_(2n−1), 16_2n, or a signal indicating whether or not a transition of the opened/closed state is required in order to reach the opened/closed state to be transitioned to.

The output circuit 34 converts the signal indicating the determination result, that is, the signal representing the path between the terminals connected in the cell balance circuit 15, into a format which can be transmitted from the cell balance control signal terminal CB_CTL to the signal input terminal CTL of the semiconductor chip 40, and supplies the signal to the cell balance control signal terminal CB_CTL.

The signal supplied to the cell balance control signal terminal CB_CTL of the semiconductor chip 30 is transmitted to the signal input terminal CTL of the semiconductor chip 40, and supplied from the signal input terminal CTL to the control circuit 43. The control circuit 43 generates a control signal for controlling the opening/closing of the switches 16_1, 16_2, . . . , 16_(2n−1), 16_2n based on the supplied signal. The control circuit 43 supplies the generated control signal to the respective control ports of the switches 16_1, 16_2, . . . , 16_(2n−1), 16_2n. The switch circuit 16 receives the control signal from the control circuit 43 and executes or stops the cell balance operation.

As described above, according to the cell balance circuit 15 and the cell balance device 41, the charge/discharge control circuit 50, the charge/discharge control device 60, and the battery device 61 including the cell balance circuit 15, there is a difference that the control circuit 13 in the charge/discharge control circuit 10 is divided into the control circuit 33 and the control circuit 43, and the output circuit 34 connecting the control circuit 33 and the control circuit 43, but the operation thereof is substantially the same. Thus, according to the cell balance circuit 15, the cell balance device 41, the charge/discharge control circuit 50, the charge/discharge control device 60, and the battery device 61, the same effects as those of the charge/discharge control circuit 10, the charge/discharge control device 20, and the battery device 1 can be achieved.

Further, in the charge/discharge control circuit 50, the charge/discharge control device 60, and the battery device 61, the cell balance device 41 which performs the cell balance operation is formed on the semiconductor chip 40 which is different from the semiconductor chip 30 which is responsible for the charge/discharge control operation of the secondary battery 2. Since the depletion type FET 17 which generates heat due to the cell balance operation is arranged outside the semiconductor chip 30, it is possible to provide the charge/discharge control circuit 50, the charge/discharge control device 60, and the battery device 61 which are not easily affected by the heat generated by the cell balance operation.

### Third Embodiment

Structurally, the cell balance circuit, the charge/discharge control circuit, the charge/discharge control device, and the battery device according to the third embodiment correspond to a case where the number of cells of the secondary battery 2A is 2, that is, a case of n=2, with respect to the cell balance circuit, the charge/discharge control circuit, the charge/discharge control device, and the battery device according to the first embodiment in which the number of cells of the secondary battery 2 is n (n≥2). Thus, the configuration of the cell balance circuit, the charge/discharge control circuit, the charge/discharge control device, and the battery device according to the third embodiment will be described by interpreting the description of the cell balance circuit, the charge/discharge control circuit, the charge/discharge control device, and the battery device according to the first embodiment based on n=2.

In the third embodiment, the descriptions overlapping with those of the first embodiment will be omitted or simplified, and the points different from the first embodiment will be mainly described. In the descriptions of the third embodiment and the fourth embodiment, the cell connection terminals VC(n−1)a and VC(n−1)b in the case of n=2 are not referred to as cell connection terminals VC1a and VC1b, but are referred to as cell connection terminals VCa and VCb.

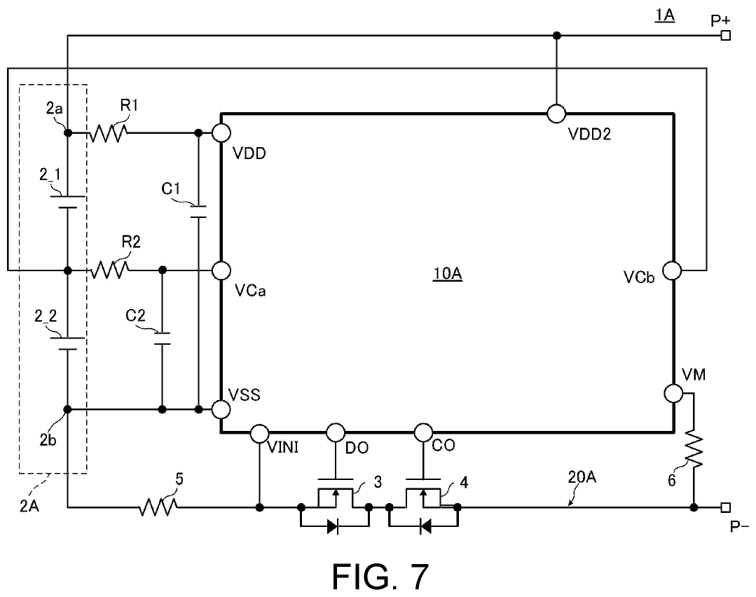

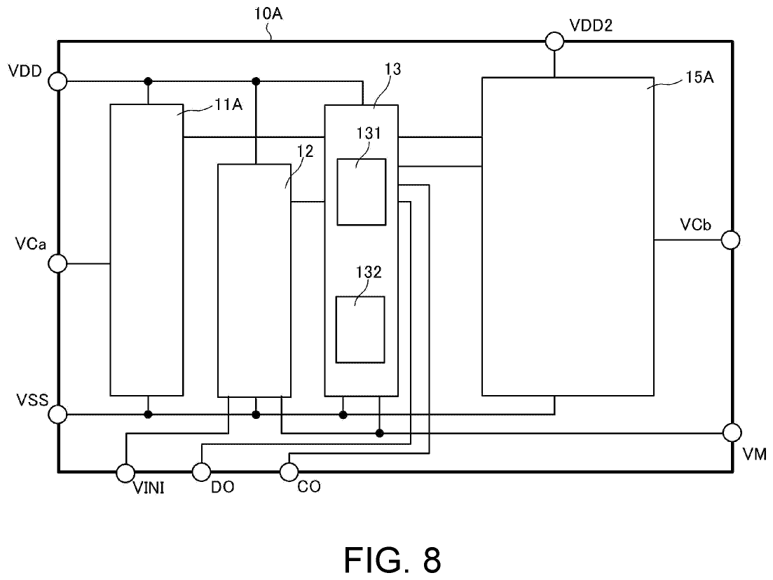

The cell balance circuit 15A, the charge/discharge control circuit 10A, the charge/discharge control device 20A, and the battery device 1A (see FIG. 7 to FIG. 9) are examples of the cell balance circuit, the charge/discharge control circuit, the charge/discharge control device, and the battery device according to the third embodiment, respectively, and relate to a case where the secondary battery 2 of the cell balance circuit 15, the charge/discharge control circuit 10, the charge/discharge control device 20, and the battery device 1 (see FIG. 1 to FIG. 3) is the secondary battery 2A including a so-called two-cell configuration battery pack. Here, the battery voltage detection circuit 11A, the cell balance circuit 15A, and the switch circuit 16A are the battery voltage detection circuit 11, the cell balance circuit 15, and the switch circuit 16 corresponding to the secondary battery 2A, respectively.

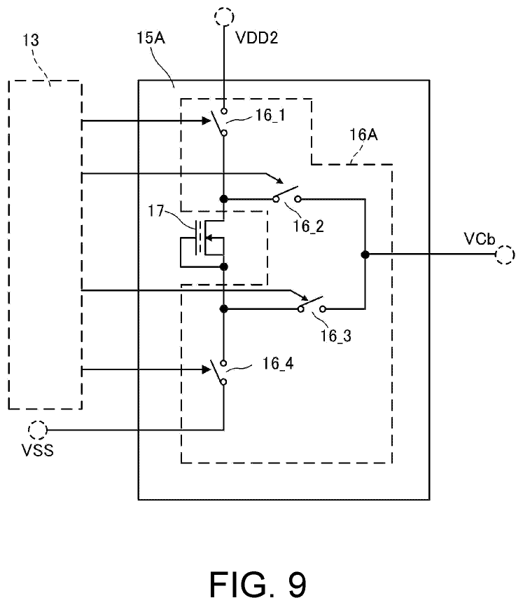

The switch circuit 16A includes four switches 16_1, 16_2, 16_3, 16_4 which are twice the number of the two cells of the secondary battery 2A (see FIG. 9). As the switch circuit 16 includes the switches 16_1 to 16_4, the switch circuit 16 is configured to be capable of opening/closing the first path connecting the positive electrode terminal and the negative electrode terminal of the first cell 2_1 and the second path connecting the positive electrode terminal and the negative electrode terminal of the second cell 2_2. Here, in the switches 16_1, 16_2, 16_3, 16_4, the ports connected to the positive electrode terminals or the negative electrode terminals of the first cell 2_1 and the second cell 2_2 are referred to as the first ports, and the ports connected to the drain or source of the depletion type FET 17 are referred to as the second ports.

Next, the operation of the cell balance circuit 15A, the charge/discharge control circuit 10A, the charge/discharge control device 20A, and the battery device 1A will be described.

The charge/discharge control operation of the secondary battery 2A in the charge/discharge control circuit 10A, the charge/discharge control device 20A, and the battery device 1A is the same as the charge/discharge control operation of the secondary battery 2 in the charge/discharge control circuit 10, the charge/discharge control device 20, and the battery device 1 described above. Further, the charge/discharge control circuit 10A, the charge/discharge control device 20A, and the battery device 1A perform the cell balance operation for adjusting the individual voltages of the first cell 2_1 and the second cell 2_2.

In the charge/discharge control circuit 10A (more specifically, the control circuit 13), an overcharge detection voltage VCU (>0) for starting the operation of overcharge protection and an overcharge release voltage VCL (>0) for releasing (stopping) the operation of overcharge protection are set for each of the first cell 2_1 and the second cell 2_2. Further, in the charge/discharge control circuit 10A (more specifically, the control circuit 13), the conditions that the voltage of the secondary battery 2A is lower than the overcharge release voltage VCL and that the discharge from the secondary battery 2A to the load connected between the external terminals is started are set as the conditions for releasing the operation of overcharge protection.

In a general charge/discharge control circuit, the overcharge release voltage VCL is set to be equal to or lower than the overcharge detection voltage VCU. In contrast, in the charge/discharge control circuit 10A, the overcharge detection voltage VCU is set to a voltage higher than a voltage (hereinafter simply referred to as “reference voltage”) which is ½ times the charge voltage VCH (>0), which is the output voltage of the charger connected between the external terminals, and lower than the charge voltage VCH. Furthermore, the overcharge release voltage VCL is set to a voltage lower than the reference voltage. That is, the overcharge release voltage VCL and the overcharge detection voltage VCU are set with the reference voltage in between within a range of less than the charge voltage VCH.

The above-mentioned setting range is a setting for balancing the voltages of the first cell 2_1 and the second cell 2_2 without overcharging. While satisfying this setting condition, it is possible to set more preferable setting conditions of the overcharge release voltage VCL and the overcharge detection voltage VCU. More preferable setting conditions of the overcharge release voltage VCL and the overcharge detection voltage VCU will be described in the description of the cell balance operation of the first cell 2_1 and the second cell 2_2, which will be described later.

Subsequently, the cell balance operation of the first cell 2_1 and the second cell 2_2 will be described. In the charge/discharge control circuit 10A, similar to the charge/discharge control circuit 10 described above, the cell balance operation is started when the operation start condition is satisfied, and the cell balance operation is stopped when the operation stop condition is satisfied. That is, after the operation start condition of the cell balance operation is satisfied, the charge/discharge control circuit 10A transitions between the cell balance operation state and the cell balance stop state according to the respective voltages of the first cell 2_1 and the second cell 2_2 detected by the battery voltage detection circuit 11A.

Subsequently, the relationship between the voltage of the first cell 2_1 and the voltage of the second cell 2_2 and the cell balance operation state and the cell balance stop state will be described more specifically.

When the voltage of the first cell 2_1 is equal to or higher than the overcharge detection voltage VCU and the overcharge state of the first cell 2_1 is detected, it is a state where the depletion type FET 17 is connected in parallel to the first cell 2_1 (hereinafter referred to as “first cell discharge state”). When the voltage of the second cell 2_2 is equal to or higher than the overcharge detection voltage VCU and the overcharge state of the second cell 2_2 is detected, it is a state where the depletion type FET 17 is connected in parallel to the second cell 2_2 (hereinafter referred to as “second cell discharge state”). In addition, when neither the voltage of the first cell 2_1 nor the voltage of the second cell 2_2 is detected to be in the overcharge state, it is the cell balance stop state in which the depletion type FET 17 is not connected to either the first cell 2_1 or the second cell 2_2.

The generation of a control signal for transitioning between the cell balance operation state and the cell balance stop state, that is, a control signal for adjusting the individual voltages of the first cell 2_1 and the second cell 2_2, is performed by the cell balance control circuit 132. For example, after the operation start condition of the cell balance operation is satisfied, when the overcharge state of the first cell 2_1 is detected, the charge/discharge control circuit 10A transitions to the first cell discharge state and then transitions to the cell balance stop state. When the discharge of the first cell 2_1 is stopped, the voltage of the first cell 2_1 becomes the overcharge release voltage VCL while the voltage of the second cell 2_2 becomes a predetermined voltage which is equal to or higher than the overcharge release voltage VCL and less than the reference voltage (=VCH/2) due to the configuration of the secondary battery 2 and the relationship of the charge voltage VCH. This predetermined voltage is a voltage determined by the difference between the overcharge detection voltage VCU and the reference voltage.

A case where the overcharge state of the second cell 2_2 is detected after the operation start condition of the cell balance operation is satisfied is that the first cell 2_1 and the first cell discharge state are respectively replaced with the second cell 2_2 and the second cell discharge state in the description with respect to the first cell 2_1. That is, after the discharge of the second cell 2_2 is stopped, the voltage of the second cell 2_2 becomes the overcharge release voltage VCL, and the voltage of the first cell 2_1 becomes a predetermined voltage which is equal to or higher than the overcharge release voltage VCL and less than the reference voltage.

Subsequently, more preferable setting conditions of the overcharge release voltage VCL and the overcharge detection voltage VCU will be described. In the cell balance operation, if the voltage to be reduced by the discharge is large, the time to completion of the cell balance operation becomes longer than in the case where the voltage to be reduced by the discharge is small. From the viewpoint of shortening the time of the cell balance operation, it is preferable to make the difference between the overcharge detection voltage VCU and the overcharge release voltage VCL small. However, since the difference between the overcharge detection voltage VCU and the overcharge release voltage VCL is determined by design items which take into consideration the operational stability between overcharge detection and overcharge release, it may be difficult to make the difference excessively small.

On the other hand, it is preferable that the overcharge release voltage VCL and the overcharge detection voltage VCU have a small deviation between the difference between the reference voltage and the overcharge release voltage VCL (VCH/2−VCL) and the difference between the overcharge detection voltage VCU and the reference voltage (VCU−VCH/2). That is, the absolute value |VCU+VCL−VCH| of the difference between them is preferably closer to 0, and more preferably 0 (zero). This is because, as the absolute value |VCU+VCL−VCH| of the difference between them gets closer to 0, the difference between the voltage of the first cell 2_1 and the voltage of the second cell 2_2 at the time when the cell balance operation is completed can be made smaller.

From the respective possible ranges of the overcharge release voltage VCL and the overcharge detection voltage VCU described above, the absolute value |VCU+VCL−VCH| of the difference between them has a value smaller than the reference voltage (=VCH/2). That is, the following equation (1) is satisfied.

0≤|VCU+VCL−VCH|<VCH/2 (1)

The following equation (2) can be derived by expanding the absolute value of the above equation (1) and rearranging the equation.

VCH/2<VCU+VCL<3VCH/2 (2)

Equation (2) indicates that the sum of the overcharge release voltage VCL and the overcharge detection voltage VCU can be set within a range including the charge voltage VCH. When the absolute value |VCU+VCL−VCH| of the difference between them is made small, the upper limit and the lower limit of the equation (2) narrow the range toward the charge voltage VCH.

When the more preferable absolute value |VCU+VCL−VCH| of the difference between them is 0, the sum of the overcharge release voltage VCL and the overcharge detection voltage VCU is equal to the charge voltage VCH. That is, it is a case which satisfies the following equation (3).

VCU+VCL=VCH (3)

According to the present embodiment, the circuit for performing the cell balance operation includes the cell balance control circuit 132 which generates a control signal for adjusting the individual voltages of the first cell 2_1 and the second cell 2_2, and the cell balance circuit 15A which can cause a cell balance current to flow from the first cell 2_1 or the second cell 2_2, which is the switching destination, via the cell discharge resistor. That is, compared with the conventional circuit for performing the cell balance operation, which includes a circuit for measuring the voltage of each battery cell and a circuit for comparing the measured voltages, the circuit for performing the cell balance operation of the present embodiment has fewer circuits and can simplify the configuration. Besides, after the cell balance operation, the voltage of the cell in which the overcharge detection voltage VCU is detected, among the first cell 2_1 and the second cell 2_2, can be lowered to the overcharge release voltage VCL which is the target voltage.

Further, in the charge/discharge control circuit 10A, the charge/discharge control device 20A, and the battery device 1A including the cell balance circuit 15A, the cell balance operation is executed by, for example, leaving the charger connected for a long time or leaving the secondary battery 2A alone without connecting the apparatus to the external terminal after charging. As described above, the charge/discharge control circuit 10A, the charge/discharge control device 20A, and the battery device 1A including the cell balance circuit 15A can easily execute the cell balance operation, and can keep the variation between the voltage of the first cell 2_1 and the voltage of the second cell 2_2 small.

In addition, in the charge/discharge control circuit 10A, the charge/discharge control device 20A, and the battery device 1A including the cell balance circuit 15A, the set values of the overcharge detection voltage VCU and the overcharge release voltage VCL are set in the preferable range so that it is possible to keep the variation between the voltage of the first cell 2_1 and the voltage of the second cell 2_2 at the time when the cell balance operation is completed smaller. That is, the voltage of the first cell 2_1 and the voltage of the second cell 2_2 at the time when the cell balance operation is completed can be brought closer.

More preferably, the overcharge detection voltage VCU and the overcharge release voltage VCL may be set to satisfy the above equation (3). By setting the overcharge detection voltage VCU and the overcharge release voltage VCL to satisfy the above equation (3), the voltage of the first cell 2_1 and the voltage of the second cell 2_2 at the time when the cell balance operation is completed can be made the same.

Further, in the charge/discharge control circuit 10A, the charge/discharge control device 20A, and the battery device 1A including the cell balance circuit 15A, the cell balance operation state and the cell balance stop state can be switched according to the state of the secondary battery 2A (first cell 2_1 and second cell 2_2) or the connection with the charger. Furthermore, the transition to the cell balance operation state is made after confirming that the above-mentioned condition (I) or (II), which is the operation start condition of the cell balance operation, is satisfied. Thus, it is possible to suppress the discharge of the secondary battery 2A due to an unnecessary cell balance operation.

The cell balance circuit 15A and the charge/discharge control circuit 10A, the charge/discharge control device 20A, and the battery device 1A including the cell balance circuit 15A include the depletion type FET 17 which includes the first port connected to the positive electrode terminals of the first cell 2_1 and the second cell 2_2 via the switch circuit 16A, and the second port connected to the negative electrode terminals of the first cell 2_1 and the second cell 2_2 via the switch circuit 16A. In the cell balance circuit 15A and the charge/discharge control circuit 10A, the charge/discharge control device 20A, and the battery device 1A including the cell balance circuit 15A, with one depletion type FET 17, it is possible to switch the switches 16_1 to 16_4 open/close (open or short circuit) to selectively discharge the first cell 2_1 and the second cell 2_2.

In the cell balance circuit 15A and the charge/discharge control circuit 10A, the charge/discharge control device 20A, and the battery device 1A including the cell balance circuit 15A, the configuration of the cell discharge resistor can be simplified, and it is possible to perform the cell balance operation with an accuracy equal to or higher than the conventional technique.

In the charge/discharge control circuit 10A, the charge/discharge control device 20A, and the battery device 1A described above, when a specific condition is satisfied, the operation stop condition of the cell balance operation may be set even before the cell in which the overcharge detection voltage VCU is detected, among the first cell 2_1 and the second cell 2_2, drops to the overcharge release voltage VCL. For example, a timing when it is preferable to suppress the discharge of the first cell 2_1 and the second cell 2_2 is set as the operation stop condition of the cell balance operation.

A case where at least one of the following is satisfied is an example of the timing when it is preferable to suppress the discharge of the first cell 2_1 and the second cell 2_2:

(i) the discharge from the secondary battery 2A to the apparatus which is the load has started, and

(ii) the charger non-connection state.

Whether or not the condition (i) or (ii) is satisfied is determined by the control circuit 13 or the control circuit 33 based on at least one of the voltage detected by the battery voltage detection circuit 11, the voltage Vss of the negative electrode power supply terminal VSS, and the voltage Vm of the external negative voltage input terminal VM.

According to the charge/discharge control circuit 10A, the charge/discharge control device 20A, and the battery device 1A in which the operation stop condition of the cell balance operation is set even before the cell in which the overcharge detection voltage VCU is detected drops to the overcharge release voltage VCL, the cell balance operation is stopped at the timing when it is desired to suppress the discharge of the first cell 2_1 and the second cell 2_2. Thus, the energy loss associated with the cell balance operation can be reduced.

### Fourth Embodiment

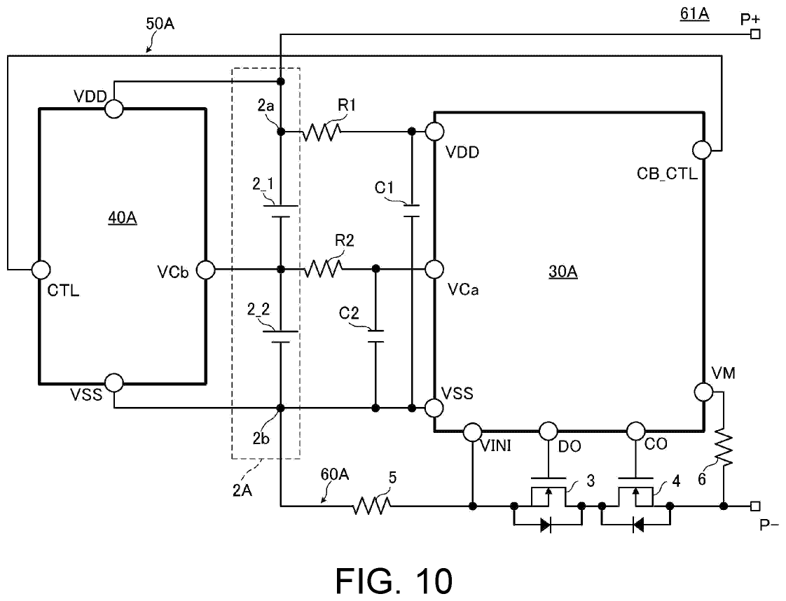

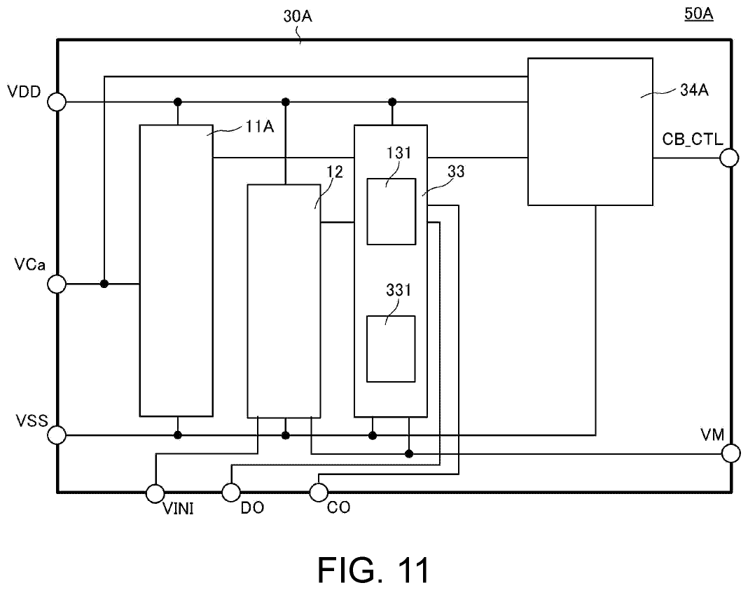

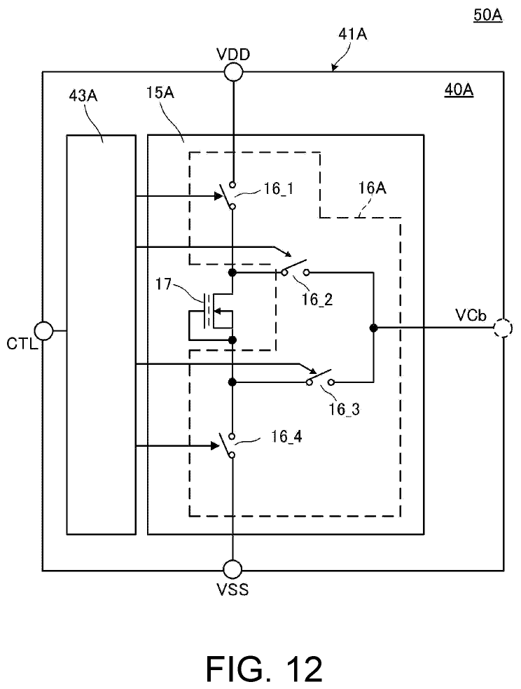

FIG. 10 is a schematic diagram illustrating a configuration example of the cell balance device, the charge/discharge control circuit, the charge/discharge control device, and the battery device according to the fourth embodiment. FIG. 11 is a schematic diagram illustrating a more detailed configuration example of the charge/discharge control circuit 50A as the charge/discharge control circuit according to the fourth embodiment. FIG. 12 is a schematic diagram illustrating a more detailed configuration example of the cell balance circuit 15A as the cell balance circuit according to the fourth embodiment.

Structurally, the cell balance circuit, the charge/discharge control circuit, the charge/discharge control device, and the battery device according to the fourth embodiment correspond to a case where the number of cells of the secondary battery 2A is 2, that is, a case of n=2, with respect to the cell balance circuit, the charge/discharge control circuit, the charge/discharge control device, and the battery device according to the second embodiment in which the number of cells of the secondary battery 2 is n (n≥2). Thus, the configuration of the cell balance circuit, the charge/discharge control circuit, the charge/discharge control device, and the battery device according to the fourth embodiment will be described by interpreting the description of the cell balance circuit, the charge/discharge control circuit, the charge/discharge control device, and the battery device according to the second embodiment based on n=2.

Further, the relationship between the fourth embodiment and the third embodiment is the same as the relationship between the second embodiment and the first embodiment. That is, the battery device 61A and the charge/discharge control device 60A are respectively different from the battery device 1A and the charge/discharge control device 20A in that the battery device 61A and the charge/discharge control device 60A include the charge/discharge control circuit 50A instead of the charge/discharge control circuit 10A, but are the same in the other points.

In addition, the charge/discharge control circuit 50A is different from the charge/discharge control circuit 10A in that the FET control circuit 131 and the cell balance circuit 15A are formed on two semiconductor chips 30A and 40A which are different from each other, in that the charge/discharge control circuit 50A includes the control circuit 33 having the FET control circuit 131 instead of the control circuit 13 having the FET control circuit 131 and the cell balance control circuit 132, and the control circuit 43A corresponding to the cell balance control circuit 132, in that the control circuit 43A and the cell balance circuit 15A are configured as the independent cell balance device 41A, and in that the output circuit 34A connecting the control circuit 33 and the control circuit 43A is further provided in the semiconductor chip 30A, and the charge/discharge control circuit 50A is configured in the same manner as the charge/discharge control circuit 10A except for the above differences. In the fourth embodiment, the descriptions overlapping with those of the first embodiment, the second embodiment, and the third embodiment will be omitted or simplified, and the points different from the first embodiment, the second embodiment, and the third embodiment will be mainly described.

The cell balance circuit 15A, the charge/discharge control circuit 50A, the charge/discharge control device 60A, and the battery device 61A relate to a case where the secondary battery 2 of the cell balance circuit 15, the charge/discharge control circuit 50, the charge/discharge control device 60, and the battery device 61 (see FIG. 4 to FIG. 6) is the secondary battery 2A. Here, the semiconductor chips 30A and 40A, the output circuit 34A, the cell balance device 41A, and the control circuit 43A are the semiconductor chips 30 and 40, the output circuit 34, the cell balance device 41, and the control circuit 43 corresponding to the secondary battery 2A, respectively.

The cell balance device 41A, the charge/discharge control circuit 50A, the charge/discharge control device 60A, and the battery device 61A configured in this way are respectively different from the charge/discharge control circuit 10A, the charge/discharge control device 20A, and the battery device 1 in that the cell balance operation is performed in the cell balance device 41A, but there is no substantial difference in performing the charge/discharge control operation and the cell balance operation of the secondary battery 2A described above. Further, the operation of the cell balance device 41A is different from the operation of the cell balance device 41 in that more preferable setting conditions of the overcharge release voltage VCL and the overcharge detection voltage VCU are set for the cell balance operation, but there is no substantial difference in the other points.

Specifically, in the cell balance operation in the charge/discharge control circuit 50A, the charge/discharge control device 60A, and the battery device 61A, first, the control circuit 33 determines whether to set to any of the first cell discharge state, the second cell discharge state, and the cell balance stop state based on the voltage detected by the battery voltage detection circuit 11A, the voltage Vss of the negative electrode power supply terminal VSS, and the voltage Vm of the external negative voltage input terminal VM, and supplies a signal indicating the determination result to the output circuit 34A. The signal indicating the determination result is a signal representing the path between the terminals connected in the cell balance circuit 15A and can be, for example, a signal indicating the opened/closed state to be transitioned for each switch 16_1 to 16_4, or a signal indicating whether or not a transition of the opened/closed state is required in order to reach the opened/closed state to be transitioned to.

The output circuit 34A converts the signal indicating the determination result, that is, the signal representing the path between the terminals connected in the cell balance circuit 15A, into a format which can be transmitted from the cell balance control signal terminal CB_CTL to the signal input terminal CTL of the semiconductor chip 40A, and supplies the signal to the cell balance control signal terminal CB_CTL.

The signal supplied to the cell balance control signal terminal CB_CTL of the semiconductor chip 30A is transmitted to the signal input terminal CTL of the semiconductor chip 40A, and supplied from the signal input terminal CTL to the control circuit 43A. The control circuit 43A generates a control signal for controlling the opening/closing of the switches 16_1 to 16_4 based on the supplied signal. The control circuit 43A supplies the generated control signal to the respective control ports of the switches 16_1 to 16_4. The switch circuit 16 receives the control signal from the control circuit 43A and executes or stops the cell balance operation.

According to the present embodiment, the cell balance circuit 15A and the cell balance device 41A, the charge/discharge control circuit 50A, the charge/discharge control device 60A, and the battery device 61A including the cell balance circuit 15A are configured so that the control circuit 13 is divided into the control circuit 33 and the control circuit 43A, and the output circuit 34A connecting the control circuit 33 and the control circuit 43A. On the other hand, the operation of the cell balance circuit 15A, the cell balance device 41A, the charge/discharge control circuit 50A, the charge/discharge control device 60A, and the battery device 61A is substantially the same as the operation of the cell balance circuit 15A and the charge/discharge control circuit 10A, the charge/discharge control device 20A, and the battery device 1A including the cell balance circuit 15A. Thus, according to the cell balance circuit 15A, the cell balance device 41A, the charge/discharge control circuit 50A, the charge/discharge control device 60A, and the battery device 61A, the same effects as those of the charge/discharge control circuit 10A, the charge/discharge control device 20A, and the battery device 1A can be achieved.

Furthermore, in the charge/discharge control circuit 50A, the charge/discharge control device 60A, and the battery device 61A, the cell balance device 41A which performs the cell balance operation is formed on the semiconductor chip 40A which is different from the semiconductor chip 30A which is responsible for the charge/discharge control operation of the secondary battery 2A. Since the depletion type FET 17 which generates heat due to the cell balance operation is arranged outside the semiconductor chip 30A, it is possible to provide the charge/discharge control circuit 50A, the charge/discharge control device 60A, and the battery device 61A which are not easily affected by the heat generated by the cell balance operation.

Nevertheless, the present invention is not limited to the above-described embodiments, and it is possible to implement the present invention in various forms other than the above-described examples at the stage of implementation. Various omissions, replacements, and changes can be made without departing from the gist of the present invention.

The charge/discharge control devices 20, 60, 20A, and 60A and the battery devices 1, 61, 1A, and 61A described above illustrate a configuration example in which the discharge control FET 3 and the charge control FET 4 are provided on the side of the external negative electrode terminal P−, that is, the low side, in the path between the external terminals, but the present invention is not limited to this configuration example. The charge/discharge control device and the battery device according to the embodiments may include the discharge control FET 3 and the charge control FET 4 on the side of the external positive electrode terminal P+, that is, the high side.

The charge/discharge control circuits 10, 50, 10A, and 50A described above illustrate a configuration example including the overcurrent detection terminal VINI, but the present invention is not limited to this configuration example. Further, the charge/discharge control devices 20, 60, 20A, and 60A and the battery devices 1, 61, 1A, and 61A described above illustrate a configuration example including the overcurrent detection resistor 5 and the overcurrent detection terminal VINI, but the present invention is not limited to this configuration example. In the charge/discharge control circuit according to the embodiments, the overcurrent detection terminal VINI is an optional component and may be omitted. In the charge/discharge control device and the battery device according to the embodiments, the overcurrent detection resistor 5 and the overcurrent detection terminal VINI are optional components and may be omitted.

The charge/discharge control circuits 10, 50, 10A, and 50A, the charge/discharge control devices 20, 60, 20A, and 60A, and the battery devices 1, 61, 1A, and 61A described above illustrate a configuration example including the depletion type FET 17 as the cell discharge resistor, but the cell discharge resistor is not limited to the depletion type FET 17. The cell discharge resistor may be any element having a current limiting function, and may be, for example, a transistor on-resistance, a resistance element, or a combination thereof.

When forming the cell balance device, the charge/discharge control circuit, the charge/discharge control device, and the battery device according to the present embodiment, the charge/discharge control circuits 10 and 10A may be divided into the cell balance circuits 15 and 15A, and other battery voltage detection circuits 11 and 11A, overcurrent detection and release circuit 12, and control circuit 13 to be respectively formed on different semiconductor chips.

In addition, the charge/discharge control circuits 50 and 50A, the charge/discharge control devices 60 and 60A, and the battery devices 61 and 61A described above illustrate an example in which the cell balance devices 41 and 41A include the control circuits 43 and 43A, but the present invention is not limited to this example. When forming the cell balance device, the charge/discharge control circuit, the charge/discharge control device, and the battery device according to the present embodiment, the control circuits 43 and 43A are not necessarily provided in the cell balance devices 41 and 41A. If the desired control signal can be supplied to the switch circuits 16 and 16A in the cell balance devices 41 and 41A, the control circuits 43 and 43A may be provided outside the cell balance devices 41 and 41A such as the semiconductor chips 30 and 30A.

In the charge/discharge control circuit 50A, the charge/discharge control device 60A, and the battery device 61A, similar to the charge/discharge control circuit 10A, the charge/discharge control device 20A, and the battery device 1A, when a specific condition is satisfied, the operation stop condition of the cell balance operation may be set even before the cell in which the overcharge detection voltage VCU is detected drops to the overcharge release voltage VCL.

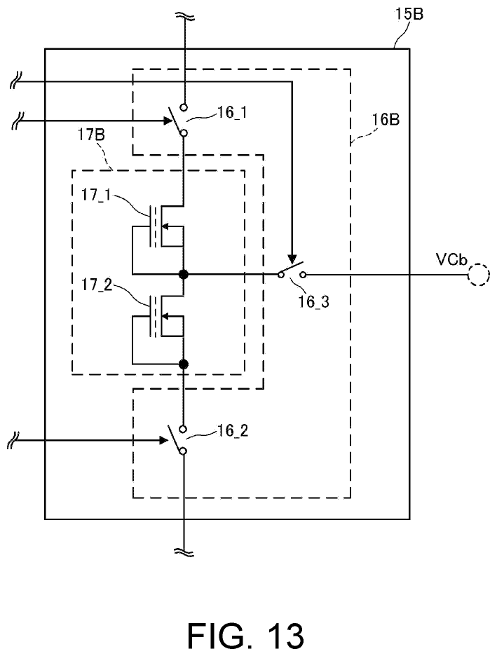

The cell balance circuit 15A described above is not limited to the configurations illustrated in FIG. 9 and FIG. 12, and other configurations such as the cell balance circuit 15B illustrated in FIG. 13 may be adopted according to the configurations of the switch circuit 16A and the cell discharge resistor.

FIG. 13 is a schematic diagram illustrating a configuration example of the cell balance circuit 15B, which is a modified example of the cell balance circuit according to an embodiment of the present invention.

Compared with the cell balance circuit 15A, the cell balance circuit 15B is configured to include a switch circuit 16B and a depletion type FET 17B (17_1, 17_2) instead of the switch circuit 16A and the depletion type FET 17 as the cell discharge resistor. As described above, as long as the configuration of the switch circuit 16B can open and close the path respectively connected to the first cell 2_1 and the second cell 2_2 via the cell discharge resistor, the configuration and the number of switches thereof are not limited.

For example, if the cell discharge resistor is the depletion type FET 17B including the depletion type FET 17_1 and 17_2 connected in parallel, with a configuration including three switches 16_1, 16_2, and 16_3 such as the switch circuit 16B illustrated in FIG. 13, it is possible to switch between the first cell discharge state, the second cell discharge state, and the cell balance stop state. In the switch circuit 16B illustrated in FIG. 13, in order to enter the first cell discharge state, the switches 16_1 and 16_3 may be closed and the switch 16_2 may be opened. In order to enter the second cell discharge state, the switches 16_2 and 16_3 may be closed and the switch 16_1 may be opened. In order to enter the cell balance stop state, all the switches 16_1, 16_2, and 16_3 may be opened, or the switch 162 may be closed and the switches 16_1 and 16_3 may be opened.

The switch circuit 16B may have a configuration which includes two switches 16_1 and 16_2, omitting the switch 16_3. In the case of the switch circuit 16B which includes two switches 16_1 and 162, in order to enter the first cell discharge state, the switch 16_1 may be closed and the switch 16_2 may be opened. In order to enter the second cell discharge state, the switch 16_2 may be closed and the switch 16_1 may be opened. In order to enter the cell balance stop state, both the switches 16_1 and 16_2 may be opened.

These embodiments and modifications thereof are included in the scope and gist of the present invention, and are also included in the scope of the present invention defined in the claims and the equivalent scope thereof.

What is claimed is:

1. A cell balance circuit, which is a circuit connected in parallel to a secondary battery including a battery pack in which a first cell to an n^{th} cell are connected in series in order from a positive electrode to a negative electrode, with a natural number n which is two or more as the number of cells connected in series, and adjusting individual voltages of n cells, from the first cell to the n^{th} cell, the cell balance circuit comprising:
a switch circuit comprising at least one switch in a path connecting a positive electrode terminal and a negative electrode terminal of each of the n cells and being capable of respectively opening/closing n paths based on a control signal supplied to the at least one switch; and
a cell discharge resistor respectively connected to the n cells, from the first cell to the n^{th} cell, via the switch circuit,
the switch circuit switching to a cell balance stop state where each of the first cell to the n^{th} cell is not connected to the cell discharge resistor in response to satisfying at least one of a charger non-connection state where a charger for charging the secondary battery is not connected to an external positive electrode terminal and an external negative electrode terminal, or a state where the secondary battery is being discharged to a load connected to the external positive electrode terminal and the external negative electrode terminal.

2. The cell balance circuit according to claim 1, wherein the natural number n is equal to or more than a natural number k which is an order of the cell connected in series from the positive electrode to the negative electrode, and wherein the switch circuit is configured to receive the control signal, and switch to a k^{th} cell discharge state where a k^{th} cell from the positive electrode to the negative electrode is connected to the cell discharge resistor based upon the received control signal in a case where a voltage of the k^{th} cell is equal to or higher than an overcharge detection voltage at which an operation of overcharge protection is started, the case satisfying at least one of a charger connection state where the charger is connected to the external positive electrode terminal and the external negative electrode terminal, or a state where the secondary battery is not being discharged to the load.

3. The cell balance circuit according to claim 2, wherein the switch circuit transitions from the k^{th} cell discharge state to the cell balance stop state in response to satisfying that the voltage of the k^{th} cell has dropped from the overcharge detection voltage or more to an overcharge release voltage or less.

4. The cell balance circuit according to claim 2, wherein the switch circuit transitions from the k^{th} cell discharge state to the cell balance stop state in response to satisfying at least one of the charger non-connection state, or a state where discharge from the secondary battery to the load has been started.

5. The cell balance circuit according to claim 1,
wherein the natural number n is equal to or more than a natural number k which is an order of the cell connected in series from the positive electrode to the negative electrode,
wherein the at least one switch included in a path connecting a positive electrode terminal of a k^{th} cell, which is the k^{th} cell, and a negative electrode terminal of the k^{th} cell comprises:
a k_1^{th} switch switching between connection and non-connection with the positive electrode terminal of the k^{th} cell based on the control signal supplied, the k_1^{th} switch including a control port to which the control signal is supplied, a first port connected to the positive electrode terminal of the k^{th} cell, and a second port connected to the cell discharge resistor; and
a k_2^{th} switch switching between connection and non-connection with the negative electrode terminal of the k^{th} cell based on the control signal supplied, the k_2^{th} switch including a control port to which the control signal is supplied, a first port connected to the negative electrode terminal of the k^{th} cell, and a second port
connected to the cell discharge resistor, and
wherein the cell discharge resistor comprises:
a first end connected to each positive electrode terminal of the n cells, from the first cell to the n^{th} cell, via the k_1^{th} switch; and
a second end connected to each negative electrode terminal of the n cells, from the first cell to the n^{th} cell, via the k_2^{th} switch.

6. The cell balance circuit according to claim 1, further comprising a cell balance control circuit which controls to switch between a cell balance operation state where any one of the n cells and the cell discharge resistor are connected, and a cell balance stop state where the cell discharge resistor is not connected to any of the n cells.

7. A cell balance circuit, among circuits connected in parallel to a secondary battery comprising a battery pack in which a first cell to an n^{th} cell are connected in series in order from a positive electrode to a negative electrode, with a natural number n which is two or more as the number of cells connected in series, and adjusting individual voltages of n cells, from the first cell to the n^{th} cell, the cell balance circuit being a circuit adjusting individual voltages of a first cell and a second cell when the natural number n is two, the cell balance circuit comprising:
a switch circuit comprising at least one switch in a path connecting a positive electrode terminal and a negative electrode terminal of each of the first cell and the second cell, the switch circuit respectively opening/closing two paths based on a control signal supplied to the at least one switch; and
a cell discharge resistor respectively connected to the first cell and the second cell via the switch circuit,
wherein an overcharge detection voltage for detecting an overcharge state and an overcharge release voltage for releasing the overcharge state are respectively set for voltages of the first cell and the second cell,
the overcharge release voltage is set to a voltage lower than a voltage which is ½ times a charge voltage being an output voltage of a charger for charging the secondary battery,
the overcharge detection voltage is set to a voltage higher than the voltage which is ½ times the charge voltage and lower than the charge voltage, and
a release condition of the overcharge state in a charger connection state where the charger is connected to an external positive electrode terminal and an external negative electrode terminal is that a voltage of the cell, among the first cell and the second cell, drops to the overcharge release voltage or less, the voltage exceeding the overcharge detection voltage.

8. The cell balance circuit according to claim 7, wherein the overcharge release voltage and the overcharge detection voltage are set so as to include a value equal to the charge voltage within a possible range of a sum of the overcharge detection voltage and the overcharge release voltage.

9. A cell balance device, comprising:
the cell balance circuit according to claim 1;
a cell balance control circuit generating the control signal and supplying the control signal generated to the at least one switch;
a positive electrode power supply terminal connected to the first end of the cell discharge resistor via the switch circuit;
a negative electrode power supply terminal connected to the second end of the cell discharge resistor via the switch circuit; and
a signal input terminal connected to the cell balance control circuit.

10. A cell balance device, comprising:
the cell balance circuit according to claim 1;
a cell balance control circuit controlling to switch between a cell balance operation state where any one of the cells and the cell discharge resistor are connected, and a cell balance stop state where the cell discharge resistor is not connected to any of the cells;
a positive electrode power supply terminal connected to the first end of the cell discharge resistor via the switch circuit;
a negative electrode power supply terminal connected to the second end of the cell discharge resistor via the switch circuit;
a cell connection terminal respectively connected to the first end and the second end of the cell discharge resistor via the switch circuit; and
a signal input terminal connected to the cell balance control circuit.

11. A charge/discharge control circuit for controlling charge/discharge of a secondary battery, the charge/discharge control circuit comprising:
a positive electrode power supply terminal to which a voltage from a positive electrode of the secondary battery is supplied;
a negative electrode power supply terminal to which a voltage from a negative electrode of the secondary battery is supplied;
a cell connection terminal pair composed of a first terminal and a second terminal which are respectively connected to a contact of two adjacent cells;
an external negative voltage input terminal connected to an external negative electrode terminal;
a charge control signal output terminal outputting a charge control signal for controlling stop and permission of charge of the secondary battery;
a discharge control signal output terminal outputting a discharge control signal for controlling stop and permission of discharge of the secondary battery;
a battery voltage detection circuit respectively connected to the positive electrode power supply terminal, the first terminal, and the negative electrode power supply terminal, and detecting a voltage of the secondary battery and a voltage of each cell based on voltages supplied from the positive electrode power supply terminal, the first terminal, and the negative electrode power supply terminal;
an FET control circuit generating the charge control signal and the discharge control signal based on detection signals of the voltage of the secondary battery and the voltage of each cell from the battery voltage detection circuit;
a cell balance control circuit generating a control signal to be supplied to the at least one switch based on the detection signals of the voltage of the secondary battery and the voltage of each cell, the voltage of the negative electrode power supply terminal, and the voltage of the external negative voltage input terminal; and
the cell balance circuit according to claim 1,
wherein the second terminal is connected to the cell balance circuit.

12. The charge/discharge control circuit according to claim 11, wherein the charge/discharge control circuit is formed on a plurality of semiconductor chips,
the FET control circuit is formed on a first semiconductor chip, and
the cell balance circuit is formed on a second semiconductor chip different from the first semiconductor chip.

13. A charge/discharge control device, comprising:
the charge/discharge control circuit according to claim 11;
the external positive electrode terminal and the external negative electrode terminal;
a charge control FET comprising a gate connected to the charge control signal output terminal, a first port connected to the external negative electrode terminal, and a second port; and
a discharge control FET comprising a gate connected to the discharge control signal output terminal, and a port connected to the second port of the charge control FET.

14. A battery device, comprising:
the charge/discharge control circuit according to claim 10;
the secondary battery;
the external positive electrode terminal and the external negative electrode terminal;
a charge control FET comprising a gate connected to the charge control signal output terminal, a first port connected to the external negative electrode terminal, and a second port; and
a discharge control FET comprising a gate connected to the discharge control signal output terminal, and a port connected to the second port of the charge control FET.
